(19) United States
(12) Patent Application Publication
(10) Pub. No.: US 2013/0183219 A1
(43) Pub. Date: Jul. 18, 2013

(54) METHODS FOR REDUCING NITROGEN OXIDES EMISSIONS

(71) Applicants: Gene H. Irrgang, Horsham, PA (US); Steve Korn, Northampton, PA (US); Edward Vogel, Kulpsville, PA (US); Naresh J. Suchak, Glen Rock, NJ (US); Frank R. Fitch, Bedminster, NJ (US)

(72) Inventors: Gene H. Irrgang, Horsham, PA (US); Steve Korn, Northampton, PA (US); Edward Vogel, Kulpsville, PA (US); Naresh J. Suchak, Glen Rock, NJ (US); Frank R. Fitch, Bedminster, NJ (US)

(21) Appl. No.: 13/554,212

(22) Filed: Jul. 20, 2012

Related U.S. Application Data
(60) Provisional application No. 61/511,151, filed on Jul. 25, 2011.

(51) Int. Cl. B01D 53/56

(52) U.S. Cl. CPC B01D 53/56
USPC 423/235; 423/210

(57) ABSTRACT

A method to reduce the emission of contaminants such as nitrogen oxides from the operation of a submerged combustion vaporizer. Fuels are combusted and the combustion gases are fed to an aqueous system which heats up and vaporizes cryogenic fluids in tube bundles in the submerged combustion vaporizer. Ozone is added to the aqueous system and will react with the contaminants allowing for their removal from the aqueous system.

### CROSS REFERENCE TO RELATED APPLICATIONS

The present application claims priority from U.S. provisional patent application Ser. No. 61/511,151 filed Jul. 25, 2011.

### BACKGROUND OF THE INVENTION

The invention provides for a method to reduce emission of nitrogen oxides arising from the combustion of fuels used to heat water where tube bundles are submerged. More particularly the invention provides for a method for reducing nitrogen oxides emissions arising from the combustion of fuels in submerged combustion vaporizers.

Submerged combustion vaporizers have been used for vaporizing cryogenic and other low temperature boiling gases for years. A typical submerged combustion vaporizer or SCV is an indirect fired heat exchanger with the burner and process tube coil contained within a single vessel. The burner combustion products are discharged into a water bath which is used as the heat transfer media for vaporizing cryogenic fluids such as liquefied natural gas (LNG) in the tube coil.

As emission standards for the release of nitrogen oxides (NOₓ) to the atmosphere have been reduced, various methods for controlling these emissions have been conceived and put into practice. Recent federal and local environmental laws require very significant reduction of discharge of harmful gaseous substances into the atmosphere. Chief among such harmful air pollutants are nitrogen oxides (NOₓ). In response to strict enforcement efforts of these laws, industrial air polluters have made considerable efforts to reduce the amount of these harmful substances into the air in gaseous effluents from industrial or municipal sources. Most commonly these methods have focused on controlling the production of the nitrogen oxides during the combustion process. However, there is a limit to these methods. In combustion processes, the nitrogen oxides (NOx) are in two oxidation states, NO and NO₂. Due to high flame temperature, NOx is primarily in the form of NO which is sparingly soluble and not reactive with water or typical scrubbing solutions

Successful efforts to reduce the concentration of NOₓ in gaseous effluents often involve reacting the NOₓ in waste gases with nitrogen-based reducing agents in the gas phase such as SNCR (selective non catalytic reduction) or using catalyst such as SCR (selective catalytic reduction) processes.

Both SCR and SNCR are elevated temperature gas phase processes that operate in narrow window of process parameter and retrofitting either technology in SCV has challenges.

Another known method of removing NOₓ from gas streams involves contacting the NOₓ with ozone, by mixing an ozone containing gas stream with the bulk of flue gas stream at temperatures from 40° F. to 325° F. (4° C. to 163° C.) and also providing enough residence time thereby oxidizing NO and NO₂ to higher nitrogen oxides, such as N₂O₅ and removing the higher oxides from the gas stream by means of aqueous scrubbers.

Specific details of ozone-based NOₓ oxidation processes are disclosed in U.S. Pat. Nos. 5,206,002; 5,316,737; 5,985,223; 6,162,409; 6,197,268 and 7,303,735 the disclosures of which are incorporated herein by reference.

Ozone has been used as an oxidizer to convert the NO to the more reactive NO₂ and other compounds such as N₂O₅ in the gas phase; however, this method by itself can not be practiced with SCV since temperature in the flue gas entering the liquid pool exceeds the desirable range for oxidation with ozone and therefore does not remove nitrogen oxides to acceptable levels.

### SUMMARY OF THE INVENTION

In one embodiment of the invention, there is disclosed a method for removing contaminants from an aqueous system present in a submerged combustion vaporizer where combustion products from the submerged combustion vaporizer are fed into the aqueous system comprising feeding ozone into the aqueous system.

In a different embodiment of the invention, there is disclosed a method for removing contaminants arising from combustion products being fed into an aqueous system comprising feeding ozone into the aqueous system.

In a further embodiment of the invention, there is disclosed a method for removing contaminants arising from combustion products being fed into an aqueous system of a submerged combustion vaporizer comprising withdrawing a portion of the aqueous system, adding ozone to the withdrawn portion of the aqueous system and feeding the withdrawn portion of the aqueous system containing ozone into the aqueous system.

The contaminants include oxides of nitrogen that if left untreated can cause operational problems as well as environmental ones. The ozone is dissolved in water to oxidize the partially oxidized compounds of nitrogen produced by the combustion of a fuel gas. The combustion of fuel gas occurs in a submerged combustion vaporizer (SCV). In the SCV, the fuel gas is burned in the presence of combustion air and the hot combustion gases produced are directed below the normal level of the aqueous system contained in the vaporizer tank through a perforated tube. A separate tube bundle through which the cryogenic liquid to be vaporized is located in the vaporizer tank. As the hot combustion gases exit the perforated tube and enter the aqueous system, they heat the water and subsequently the water heats the cryogenic liquid, vaporizing it into gas. In the typical use of this equipment for vaporizing liquefied natural gas, the aqueous system operates at 60° F. (15° C.).

Ozone is dissolved in the water bath either through an external mixing system or by sparging the ozone directly into the tank creating ozone-rich water. When ozone is dissolved in the water, the water retains the dissolved ozone until it reaches its saturation concentration generating ozone-rich water in the aqueous system where contact will occur. The combustion gas stream from the perforated pipe is bubbled through the ozone-rich water. Part of the dissolved ozone from the ozone-rich water desorbs into the combustion gas bubbles as gaseous ozone.

Nitrogen oxide (NO) in the combustion gas will react with the gaseous ozone forming NO₂. The solubilities of both NO and NO₂ in water are low and therefore removal by aqueous scrubbing or absorption in water is poor. However, if adequate amounts of gaseous ozone are provided to the combustion gas bubbles, oxidation of nitrogen oxides can be further extended to higher oxides of nitrogen such as NO₃ and N₂O₅. These higher oxides of nitrogen are highly soluble in water and are immediately dissolved in the quench water thereby forming nitric acid. The effective removal of nitrogen oxides lies in ensuring there is an adequate amount of ozone available in the combustion gas bubbles.

Ozone is added in a stoichiometric quantity to the amount of higher oxides of nitrogen present, typically about 1.5 moles of ozone per mole of NO and 0.5 moles of ozone per mole of NO₂.

The amount of ozone dissolved in the water must be controlled as excessive amounts of ozone will create unacceptable amounts of residual ozone in the exhaust gas stream. In order to improve the effectiveness of NOₓ removal, combustion gas bubbles disengaging from the water at the top of the SCV should spend adequate time in the headspace of the apparatus to allow residual ozone in the gas phase to continue oxidizing remaining NOₓ prior to demisting and exhaustion to the atmosphere.

An external duct or vessel may also be utilized for providing additional residence time and volume. The demisting device generally captures mist and fine droplets and coalesces them on extended surfaces. The wet surfaces also provide excellent opportunity for higher oxides of nitrogen to dissolve in the aqueous medium and thus they may be captured and returned to the aqueous system in the tank. The mist eliminating device may be continuously or periodically washed with water from the tank. The resulting acid is neutralized with a caustic solution either directly in the quench tank or external to the tank, though the pH of the tank may be maintained neutral or slightly acidic or slightly alkaline.

### BRIEF DESCRIPTION OF THE DRAWINGS

FIG. 1 is a schematic of a submerged combustion vaporizer ozone injection system per the invention.

FIG. 2 is a schematic of a submerged combustion vaporizer ozone injection system where ozone is injected into the vaporizer through a pump and venturi.

### DETAILED DESCRIPTION OF THE INVENTION

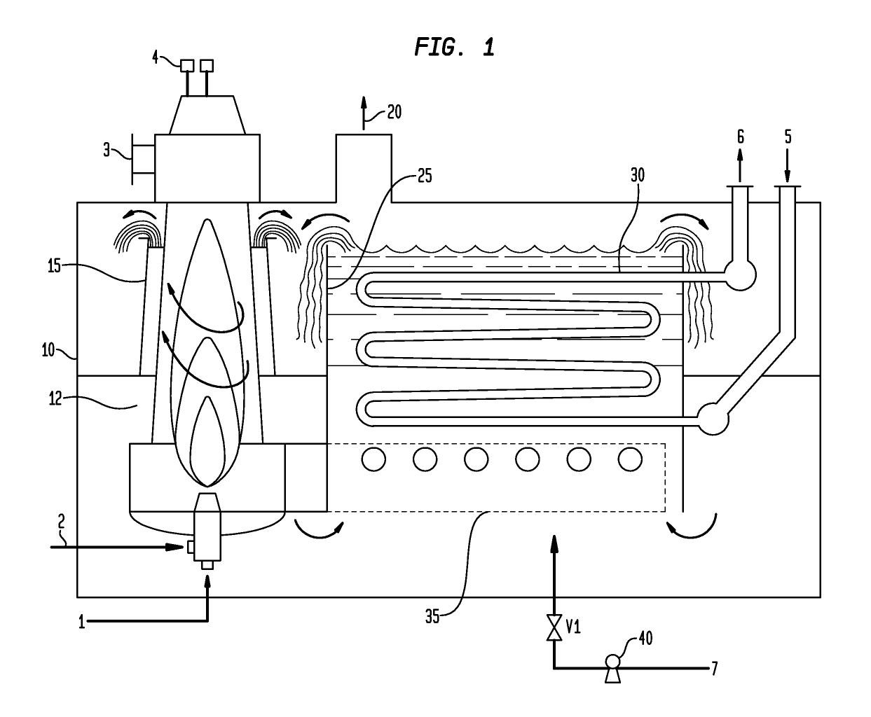

Turning to FIG. 1, a submerged combustion vaporizer (SCV) is shown. Line 1 is the feed of combustible gas into combustion burner unit 12. Line 2 feeds combustion air into the combustion burner unit 12 and combines with the combustible gas to maintain a flame. Line 3 also provides combustion air to the process and line 4 provides gas for the pilot of the combustion burner unit 12. Cooling water jacket 15 surrounds the combustion burner unit 12 to shield it from the air temperature changes in the water tank 10.

The combustion burner unit 12 provides heat to the aqueous system present in the water tank 10, which in turn heats a cryogenic fluid such as liquefied natural gas present in a tube bundle vaporizing the cryogenic fluid into gas. Hot combustion gases will enter a distributor duct with sparge tubes 35 where the hot combustion gases will heat the water present in a weir 25,

The heated water will cover the submerged tube bundle 30 where a cryogenic liquid is present. The cryogenic fluid is fed into the tube bundle 30 through feed point 5 and after being vaporized in the tube bundle 30 is withdrawn as a cryogenic gas through line 6. The weir 25 is open at the top so that heated water can fall back into the main body of water in the water tank 10 and recirculate upwards through the tube bundle 30.

The injection of the hot combustion gases into the distributor duct with sparge tubes 35 will result in the products of the combustion process (contaminants) to enter the water present in the water tank 10. These combustion products include NO which if left untreated will react with the water and form the higher oxides of nitrogen such as NO₃ and N₂O₅ which will form nitric acid which is corrosive to components in the submerged combustion vaporizer as well as being an environmental concern.

Ozone is fed through line 7 and compressor 40 (not always necessary) when valve V1 is open into or around or underneath the distributor duct with sparge tubes 35. There the ozone partially dissolves in water and ozone through aqueous phase or in gas phase enters the frothing two-phase mixture of gas and water that contains many small bubbles. Here, the ozone will react with the nitrogen oxides present in the froth as follows:

NO₂+O₃→NO₂+O₂

NO₂+O₃→NO₃+O₂

NO₃+NO₂→N₂O₅

N₂O₅ is very soluble compared to NO₂ and NO and therefore can be very easily scrubbed with water.

Ozone is injected into the froth in an amount of 1.5 moles of ozone per mole of NO and 0.5 moles of ozone per mole of NO₂.

Typically ozone is produced by an ozone generator in concentrations ranging from around 1% to 12% ozone in air or oxygen.

After treatment with the ozone, the combustion gases are greatly reduced in nitrogen oxides content and are released from the submerged combustion vaporizer through exhaust stack 20. An external duct or vessel (not shown) may also be used to provide additional residence time and volume to allow ozone to contact the combustion gases and further reduce their content of nitrogen oxides.

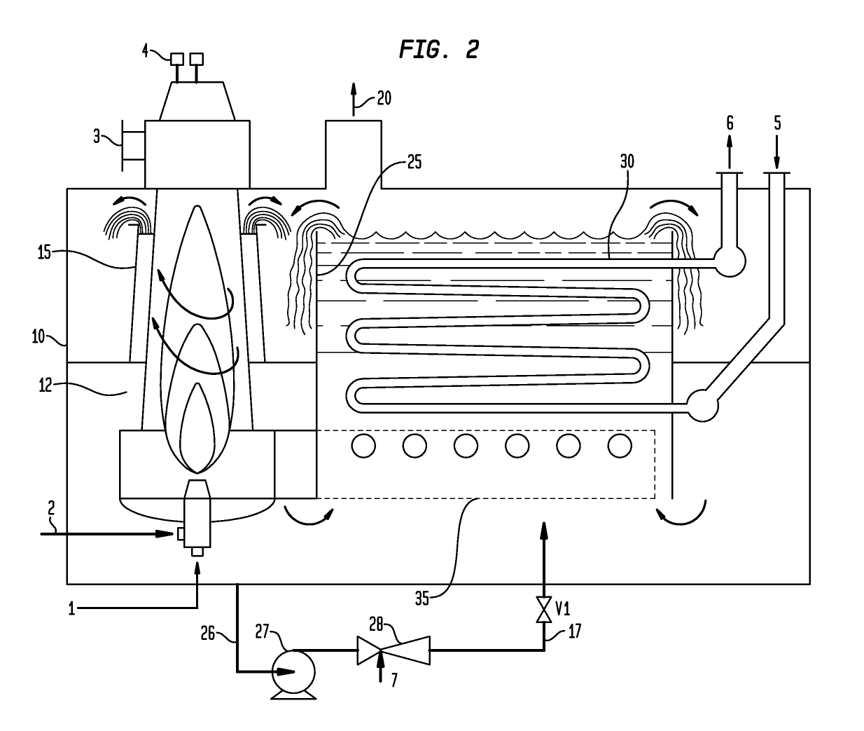

FIG. 2 shows another embodiment of the invention. The numbering as used in FIG. 1 is the same for like items in FIG. 2. Water is drawn from tank 10 by line 26 into pump 27 into venturi 28, where ozone 7 is fed to the throat of the venturi 28. A substantial amount of ozone dissolves in the water and when valve V1 is open the ozone-rich water is introduced through line 17 into, around or underneath the distributor duct with sparge tubes 35. There the ozone partially dissolves in the ozone-rich water and either through the aqueous phase or through the gas phase enters the frothing two-phase mixture of gas and water that contains many small bubbles. Frothing promotes the transfer of ozone from water back into the gas phase.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for removing contaminants from an aqueous system present in a submerged combustion vaporizer where combustion products from said submerged combustion vaporizer are fed into said aqueous system comprising feeding ozone into said aqueous system.

2. The method as claimed in claim 1 wherein said combustion products are gases.

3. The method as claimed in claim 1 wherein said contaminants are nitrogen oxides.

4. The method as claimed in claim 1 wherein said ozone is fed into said aqueous system in a stoichiometric amount based on the amount of nitrogen oxides present.

5. The method as claimed in claim 1 wherein said ozone is fed to said aqueous system by sparging.

6. The method as claimed in claim 1 wherein said ozone is mixed with water prior to feeding to said aqueous system.

7. The method as claimed in claim 1 wherein said mixing occurs in a venturi.

8. The method as claimed in claim 1 wherein said ozone is fed to said aqueous system until said aqueous system is saturated with ozone.

9. The method as claimed in claim 1 wherein dissolved ozone desorbs into said combustion gases.

10. The method as claimed in claim 1 wherein the concentration of ozone fed to said aqueous system is from about 1% to about 12% ozone in air or oxygen.

11. The method as claimed in claim 1 further comprising providing an external duct to allow for additional residence time between the ozone and said combustion gases.

12. A method for removing contaminants arising from combustion products being fed into an aqueous system comprising feeding ozone into said aqueous system.

13. The method as claimed in claim 12 wherein said aqueous system is part of a submerged combustion vaporizer.

14. The method as claimed in claim 12 wherein said combustion products are gases.

15. The method as claimed in claim 12 wherein said contaminants are nitrogen oxides.

16. The method as claimed in claim 12 wherein said ozone is fed into said aqueous system in a stoichiometric amount based on the amount of nitrogen oxides present.

17. The method as claimed in claim 12 wherein said ozone is fed to said aqueous system by sparging.

18. The method as claimed in claim 12 wherein said ozone is mixed with water prior to feeding to said aqueous system.

19. The method as claimed in claim 12 wherein said mixing occurs in a venturi.

20. The method as claimed in claim 12 wherein said ozone is fed to said aqueous system until said aqueous system is saturated with ozone.

21. The method as claimed in claim 12 wherein dissolved ozone desorbs into said combustion gases.

22. The method as claimed in claim 12 wherein the concentration of ozone fed to said aqueous system is from about 1% to about 12% ozone in air or oxygen.

23. The method as claimed in claim 12 further comprising providing an external duct to allow for additional residence time between the ozone and said combustion gases.

24. A method for removing contaminants arising from combustion products being fed into an aqueous system of a submerged combustion vaporizer comprising withdrawing a portion of said aqueous system, adding ozone to said withdrawn portion of said aqueous system and feeding said withdrawn portion of said aqueous system containing ozone into said aqueous system.

25. The method as claimed in claim 24 wherein said combustion products are gases.

26. The method as claimed in claim 24 wherein said contaminants are nitrogen oxides.

27. The method as claimed in claim 24 wherein said ozone is added into said withdrawn portion of said aqueous system in a stoichiometric amount based on the amount of nitrogen oxides present in said aqueous system.

28. The method as claimed in claim 24 wherein adding ozone is through a venturi.

29. The method as claimed in claim 24 wherein said ozone is fed to said withdrawn portion of said aqueous system until saturated with ozone.

30. The method as claimed in claim 24 wherein dissolved ozone desorbs into said combustion gases.

31. The method as claimed in claim 24 wherein the concentration of ozone fed to said aqueous system is from 1% to about 12% ozone in air or oxygen.

32. The method as claimed in claim 24 further comprising providing an external duct to allow for additional residence time between the ozone and said combustion gases.
